(19) United States
(12) Patent Application Publication
(10) Pub. No.: US 2022/0217529 A1
(43) Pub. Date: Jul. 7, 2022

(54) SYSTEMS AND METHODS FOR SERVICE STATUS TRACKER WITH SERVICE REQUEST PARAMETER MODIFICATION CAPABILITY

(71) Applicant: Verizon Patent and Licensing Inc., Basking Ridge, NJ (US)

(72) Inventors: Michael Domenic Cefaratti, JR., New York, NY (US); Brendan Rohan, Long Island City, NY (US); Sindhurani M, Santhosapuram, Chennai (IN); Chinnangari Krishna Kishore Reddy, YSR Kadapa (IN); Chirag Patel, Iselin, NJ (US); Stephanie Miki Arndt, New York, NY (US)

(73) Assignee: Verizon Patent and Licensing Inc., Basking Ridge, NJ (US)

(21) Appl. No.: 17/140,975

(22) Filed: Jan. 4, 2021

(51) Int. Cl. H04W 8/28; H04M 1/72403; G06F 3/14

(52) U.S. Cl. CPC H04W 8/28; G06F 3/14; H04M 1/72403

(57) ABSTRACT

A system described herein may provide a technique for providing status updates relating to the fulfillment of an inter-entity service request. The status updates may be provided by a first entity associated with a first portion of the request, and may include updates indicating the fulfillment of a second portion of the request associated with a second entity. The status updates may be provided via a status tracker user interface (“UI”) that is updated based on the progress of the fulfillment of the request. The status tracker UI may be updated to include input elements to receive updated request parameters in situations where the second entity indicates to the first entity that one or more request parameters are invalid or otherwise in need of correction or modification.

### BACKGROUND

Services, such as wireless networks or services related thereto, may be provided by multiple distinct wireless network service providers (sometimes referred to as “carriers”). Users may sometimes desire to transfer certain aspects of service from one service provider to another. For example, a user may desire to receive wireless network service from a different service provider than a service provider currently providing wireless network service to the user. In such a situation, the user may desire to transfer, or “port,” their Mobile Directory Number (“MDN”), their wireless device, and/or other aspects of their current service to the new wireless network service provider.

### BRIEF DESCRIPTION OF THE DRAWINGS

FIG. 1 illustrates an example overview of one or more embodiments described herein, in which a first service provider system may provide a status tracker user interface (“UI”) for an inter-entity service request, including integrated input elements to receive updated values for request parameters invalidated by a second service provider system;

FIG. 2 illustrates an example of updated request parameters, received via the tracker UI of some embodiments, being used to successfully complete an inter-entity request;

FIG. 3 illustrates an example message, which may include an option to initiate an inter-entity service, in accordance with some embodiments;

FIGS. 4-9 illustrate examples of a status tracker UI of some embodiments indicating the progress of the fulfillment of an inter-entity service, in accordance with some embodiments;

FIG. 10 illustrates an example process for providing a status tracker user interface UI for an inter-entity service request, including integrated input elements to receive updated values for request parameters invalidated by a second service provider system;

FIG. 11 illustrates an example environment in which one or more embodiments, described herein, may be implemented;

FIG. 12 illustrates an example arrangement of a radio access network (“RAN”), in accordance with some embodiments; and

FIG. 13 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Users of services, such as wireless network services provided by distinct network providers (sometimes referred to as “carriers”) may desire to transfer certain aspects of service from one service provider to another, such as Mobile Directory Numbers (“MDNs”), User Equipment (“UEs”) such as mobile phones, tablets, or other types of wireless devices, and/or other aspects of service to the new wireless network service provider. Embodiments described herein provide for an status tracker that provides up-to-date status information regarding a service transfer request from a wireless network service provider that currently provides wireless network service (referred to herein as a “source service provider”) to a particular UE, a particular user, or the like, to another wireless network service provider (referred to herein as a “target service provider”). The status tracker of some embodiments may be provided by a target service provider system, and may include status information regarding the service transfer request from the source service provider.

Generally, such status information may indicate a status of the progress of the service transfer request. For example, the service transfer request may indicate a MDN to be transferred from the source service provider to the target service provider, an identifier of one or more UEs to be transferred (e.g., a International Mobile Subscriber Identity (“IMSI”) value, International Mobile Station Equipment Identity (WEI″) value, Subscription Permanent Identifier (“SUPI”), Globally Unique Temporary Identifier (“GUTI”), and/or other suitable identifier), user information (e.g., name, address, etc. of one or more users associated with the service to be transferred), and/or other suitable information. The service transfer request process may include the validation of such parameters by the source service provider, which may include comparing the parameters to information maintained by the source service provider. For example, the source service provider may maintain such information in databases or other systems that are proprietary, secured, and/or otherwise inaccessible by the target service provider. In some situations, the parameters of the service transfer request may not match information maintained by the source service provider. For example, when initiating the service transfer request, a user may not have immediate access to the information, may provide misspelled input, may provide outdated information, and/or may provide information that otherwise does not match the information maintained by the source service provider. The source service provider may, in such instances, provide one or more indications to the target service provider that one or more parameters of the service transfer request are invalid.

In accordance with some embodiments, the source service provider may update a status tracker accessible by the user requesting the service transfer, indicating that one or more particular parameters were indicated as invalid by the source service provider. Further, in some embodiments, the updated status tracker may provide one or more input options to provide corrected information, which may in turn be provided to the source service provider for validation. Providing a status tracker with updates to a service request associated with multiple entities (e.g., multiple wireless network service providers) may allow users to quickly view consolidated information from the multiple entities, such as status information regarding the request from the target service provider as well as indications of invalid request parameters from the source service provider. Additionally, providing such status tracker may allow users to quickly correct any issues with the service requests, thereby enhancing the user experience.

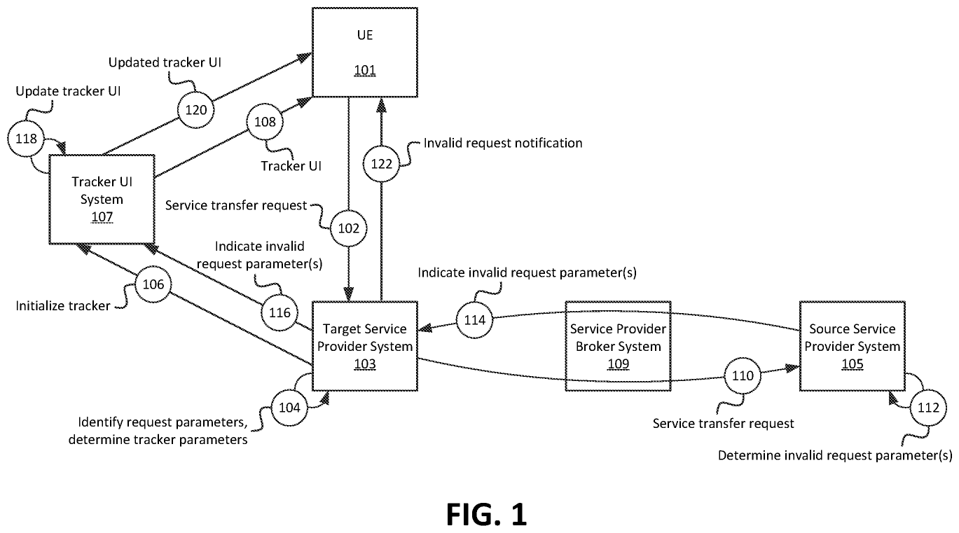

As shown in FIG. 1, for example, UE 101 may output (at 102) a service transfer request to target service provider system 103. In some embodiments, the request may be an inter-entity request (e.g., an inter-service provider request). That is, the request may be for a service associated with two distinct entities. The distinct entities may be two different service providers, such as target service provider system 103 and source service provider system 105. Target service provider system 103 may maintain proprietary information resources (e.g., data centers, databases, or the like) that are inaccessible to other service providers or entities, such as source service provider system 105. Likewise, source service provider system 105 may maintain proprietary information resources that are inaccessible to other service providers or entities, such as target service provider system 103. Such information resources may include user information resources, such as a Home Subscriber Server (“HSS”), Unified Data Management function (“UDM”), or other type of information resource. As such, source service provider system 105 may maintain or otherwise have access to information that is inaccessible to target service provider system 103, and vice versa.

For example, target service provider system 103 may be, may include, or may be communicatively coupled with one or more devices or systems associated with a service provider to which UE 101 is requesting service be transferred. For example, target service provider system 103 may be associated with a wireless network carrier that offers wireless services such as voice call services, wireless data services, or the like. A user associated with UE 101 may, for example, cause UE 101 to output (at 102) the request based on a request to affiliate UE 101 with target service provider system 103, in lieu of with source service provider system 105. For example, source service provider system 105 may be associated with a service provider that has previously provided, or is currently (e.g., at the time of request 102) providing wireless service to UE 101. Additionally, or alternatively, source service provider system 105 may include an authentication system, an input validation system, a device verification system, and/or a device or system that otherwise performs validation, verification, or the like based on input (e.g., received from UE 101).

The service transfer request may include, for example, information input via one or more user interfaces (“UIs”), web portals, applications (or “apps”), or the like. For example, the service transfer request may include authentication information (e.g., a username and password, authentication tokens, or the like), bibliographical information (e.g., name, address, or the like) associated with one or more users of UE 101, or other information that may be associated with wireless service provided by source service provider system 105 to UE 101.

Target service provider system 103 may identify (at 104) one or more parameters of the request, and may further determine one or more parameters of a status tracker associated with the request based on the one or more parameters. For example, target service provider system 103 may determine a type of request, which may include determining an identity of one or more other devices or systems with which target service provider system 103 should communicate to fulfill the request. For example, in this example, the request parameters may indicate that the request is a request to transfer one or more parameters of wireless service, provided by source service provider system 105 to UE 101, to target service provider system 103. Such parameters, which may be specified in the service transfer request, may include a MDN associated with UE 101 (e.g., based on which source service provider system 105 previously provided wireless service), an identifier associated with UE 101 (e.g., IMSI, IMEI, SUPI, GUTI, etc.), or other suitable parameters.

As noted above, the request may also include other information, such as bibliographic information, which target service provider system 103 may use to associate the request with UE 101, a user or device record maintained by target service provider system 103, or the like. In some embodiments, target service provider system 103 may validate, verify, etc. such parameters without validating, verifying, etc. other parameters of the request (e.g., parameters associated with UE 101 with respect to source service provider system 105).

Target service provider system 103 may identify (at 104) parameters of a status tracker to present in response to the service transfer request. Generally, and as further elaborated upon below, the status tracker may be generated, maintained, provided, etc. by target service provider system 103 and/or one or more devices or systems associated with target service provider system 103, such as tracker UI system 107. The status tracker may indicate a progress of the processing and/or handling of the service transfer request, and may indicate statuses such as “Request received,” “Request pending with previous carrier,” or other suitable statuses. In accordance with some embodiments, as described below, the status tracker may include interactive elements to allow a user of UE 101 to modify attributes of the request (e.g., previously entered information) in situations where such attributes include incorrect information and/or are otherwise not valid (e.g., as determined by source service provider system 105).

In some embodiments, the parameters of the status tracker may include a particular look and feel, theme, journey, or other type of presentation-related parameters. For example, different status trackers may be used for different request types. In some embodiments, different status trackers may be associated with different templates or sets of information, based on which target service provider system 103 may select an appropriate status tracker for the request (received at 102). For example, a first status tracker may be associated with service transfer requests, and a second status tracker may be associated with service cancellation requests. In some embodiments, different status trackers may include different attributes, fields, or the like, and target service provider system 103 may match parameters of the requests to such attributes, fields, or the like. For example, target service provider system 103 may determine that the request includes a code, identifier, or the like indicating that the request type is a “service transfer request.” Additionally, or alternatively, target service provider system 103 may determine information included in the request, such as address, MDN, or the like, and target service provider system 103 may select a particular status tracker template based on the inclusion of the same types of information in the status tracker template. For example, target service provider system 103 may identify a particular status tracker template that has fields, metadata, etc. that indicate that the types of information that are to be populated in the fields match the types of information included in the received request.

In some embodiments, different status trackers or status tracker templates associated with different types of requests, may be associated with different sets of statuses associated with such types of requests. For example, a service transfer request may be associated with statuses such as “Request received,” “Request pending with previous carrier,” “Request approved, line will be active shortly,” while a technical support request may be associated with statuses such as “Request received,” “Assigning request to support representative,” or other suitable statuses.

Target service provider system 103 may further initialize (at 106) an instance of the status tracker for presentation to UE 101. For example, target service provider system 103 may instruct tracker UI system 107 to generate an instance of the status tracker, where the instance of the status tracker is associated with the received request from UE 101. Initializing the status tracker may include generating one or more identifiers associated with the instance of the status tracker, one or more Uniform Resource Locators (“URLs”) or other types of locators that may be used to access the status tracker, or other suitable operations. In some embodiments, initializing the status tracker may include populating one or more fields of a status tracker template with suitable information provided in the request, and/or otherwise determined based on the request (e.g., target service provider system 103, tracker UI system 107, and/or some other device or system may obtain additional information associated with UE 101 or the user of UE 101 from a user information repository, such as a HSS, UDM, or other suitable device or system).

In some embodiments, tracker UI system 107 may further maintain state information indicating a status of the fulfillment of the request. For example, as discussed below, tracker UI system 107 may receive information from source service provider system 105 (e.g., via source service provider system 105, service provider broker system 109, target service provider system 103, and/or some other device or system) indicating the status of the fulfillment of the request. Based on the initialization (at 106), the status of the fulfillment of the request may be an initial status associated with the status tracker.

Tracker UI system 107 may generate a UI (referred to herein as a “tracker UI”) based on the status tracker. In some embodiments, the tracker UI may be a graphical user interface (“GUI”) including graphical elements (e.g., text, icons, images, or the like) that may be used to provide and receive information. For example, the tracker UI, generated based on the received request, may include an indication of some or all of the information included in, or otherwise associated with, the request. Further, the tracker UI may include one or more graphical interactive elements (e.g., buttons, text fields, menu items, or the like) via which a user may edit some or all of the information. In some embodiments, such graphical interactive elements may allow for the “in-line” editing of request parameters without reloading or re-instantiating the tracker UI, navigating away from a current page of the tracker UI, or otherwise disrupting the presentation of the tracker UI.

Tracker UI system 107 may further provide (at 108) the generated tracker UI to UE 101. For example, tracker UI system 107 may provide a URL (e.g., as generated via the initialization (at 106) of the tracker UI) via which the tracker UI may be accessed by UE 101, may provide the tracker UI to UE 101 via an application executing at UE 101, may provide the tracker UI to UE 101 via one or more application programming interfaces (“APIs”) implemented by UE 101 and/or tracker UI system 107, or in some other suitable manner.

Target service provider system 103 may also output (at 110) an indication of the service transfer request to source service provider system 105. For example, target service provider system 103 may provide the indication of the service transfer request to service provider broker system 109, which may act as an interface between target service provider system 103 and source service provider system 105. For example, service provider broker system 109 may be accessible by both target service provider system 103 and source service provider system 105, and may relay messages between target service provider system 103 and source service provider system 105. In some embodiments, target service provider system 103 and source service provider system 105 may communicate directly. The service transfer request (output at 110) may include some or all of the parameters of the service transfer request (received from UE 101 at 102), and/or additional information determined by target service provider system 103 based on the parameters included in the service transfer request (received from UE 101 at 102).

Source service provider system 105 may validate, verify, and/or otherwise evaluate some or all of the received information. For example, source service provider system 105 may perform such validation, verification, etc. in order to process the fulfillment of the request, where fulfilling the request may include modifying attributes or characteristics of service provided by source service provider system 105 to UE 101 (e.g., access to one or more wireless networks associated with source service provider system 105). In some embodiments, source service provider system 105 may determine (at 112) that one or more attributes or items of information are missing from the request. In some situations, such as the example shown here, source service provider system 105 may determine (at 112) that some or all of the provided information is invalid. For example, such invalid information may not match information maintained by source service provider system 105 associated with UE 101. For instance, source service provider system 105 may maintain information indicating that an address associated with UE 101 is “123 Elm St.” and that a MDN associated with UE 101 is “123-456-7890.” Further assume that the service transfer request (received at 110) includes an address of “345 Walnut St.” and that an MDN associated with the request is “123-456-7890.” Here, the MDN may be validated by source service provider system 105, as the MDN maintained by source service provider system 105 matches the MDN included in the request, and may determine that the address associated with the request is invalid, as the address in the request does not match the address for UE 101 maintained by source service provider system 105.

Accordingly, source service provider system 105 may indicate (at 114) to target service provider system 103 (e.g., via service provider broker system 109) that the address included in the request was invalid. Target service provider system 103 may accordingly indicate (at 116) to tracker UI system 107 that one or more parameters associated with the request are invalid (e.g., the address parameter, in this example). Tracker UI system 107 may update (at 118) the tracker UI based on the indication of the invalid parameter. For example, tracker UI system 107 may identify one or more elements of the UI associated with the presentation of the invalid parameter of the request, such as a text field, image that includes the address, etc. Tracker UI system 107 may further update the tracker UI to indicate that the information associated with the one or more elements are invalid. For example, tracker UI system 107 may highlight text in the tracker UI that includes the address parameter, may color the text differently, may include one or more icons or overlays in the tracker UI indicating that the address was invalid, and/or may provide some other suitable indicator. In some embodiments, as noted above, tracker UI system 107 may further update (at 118) the tracker UI to include one or more interactive elements (e.g., text fields, buttons, menus, list boxes, or the like) that allow the invalid parameter to be edited directly from the tracker UI.

Tracker UI system 107 may further provide (at 120) the updated tracker UI. In some embodiments, providing the updated tracker UI may include providing updated presentation information based on which UE 101 may present the updated tracker UI in a same window, application, or the like via which the tracker UI has already been presented. In some embodiments, target service provider system 103 may output (at 122) a notification that one or more parameters of the request were invalid. In some embodiments, the notification may include a URL or other locator information based on which the tracker UI (e.g., the updated tracker UI) may be accessed.

In this manner, the tracker UI may be a multi-purpose UI that not only provides the status of multi-entity processes (e.g., the service transfer associated with target service provider system 103 and source service provider system 105, discussed in this example), but also allows a user to modify parameters of such processes without requiring the user to communicate with multiple entities (e.g., placing a call to a representative associated with source service provider system 105, navigate to a separate page or UI provided by source service provider system 105, or the like).

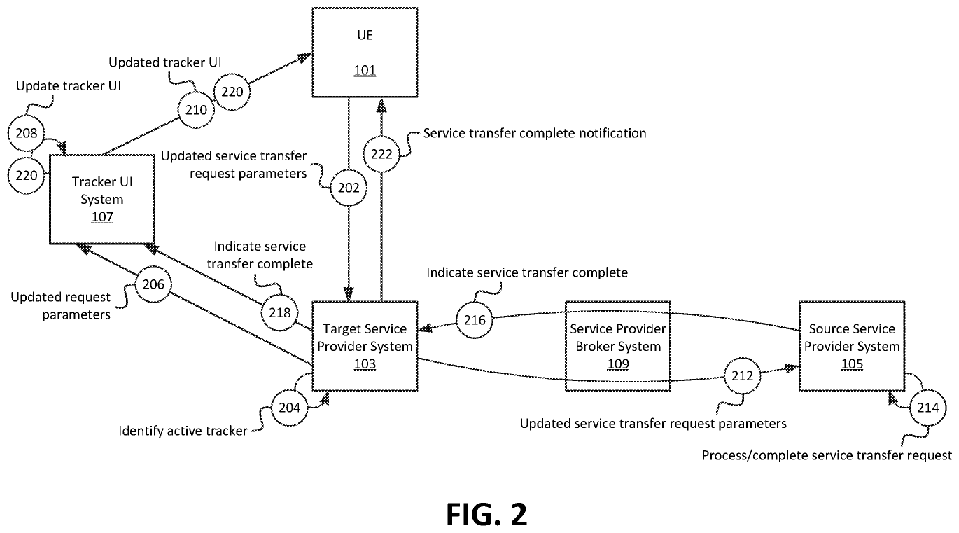

FIG. 2 illustrates an example of updated request parameters (e.g., updated based on an indication of invalid input), received via the tracker UI of some embodiments, being used to successfully complete the request. As shown, for example, UE 101 may provide (at 202) updated request parameters. For example, continuing the above example, UE 101 may receive a corrected address via the updated tracker UI, and may provide the corrected address to target service provider system 103.

Target service provider system 103 may identify (at 204) that an active instance of a tracker UI exists for UE 101 (e.g., for the request associated with UE 101), and may provide (at 206) the received updated request parameters. Additionally, or alternatively, tracker UI system 107 may determine (at 204) that an active status tracker exists for UE 101. Tracker UI system 107 may update (at 208) the tracker UI based on the received updated parameters. For example, tracker UI system 107 may modify a UI element, that presents the previously presented address (e.g., the parameter previously indicated by source service provider system 105 as invalid), to instead present the updated address received (at 202) from UE 101. Tracker UI system 107 may further update (at 208) the tracker UI to reflect a different status based on the receipt of the updated parameters. For example, tracker UI system 107 may updated the tracker UI with a status such as “Re-validating your information with your previous carrier.” Tracker UI system 107 may further present (at 210) the updated tracker UI to UE 101 (e.g., in a manner similarly discussed above with respect to operation 120).

Target service provider system 103 may additionally provide (at 212) the updated request parameters (e.g., the corrected address received from UE 101) to source service provider system 105. As discussed above, target service provider system 103 may provide the updated request parameters to source service provider system 105 via service provider broker system 109 and/or some other suitable communication pathway. Source service provider system 105 may validate, verify, etc. the updated request parameters by comparing the updated parameters to information maintained by source service provider system 105, as similarly discussed above. In this example, source service provider system 105 may determine that the updated request parameters are valid, and may proceed to process, complete, fulfill, etc. (at 214) the request. For example, source service provider system 105 may update provisioning information associated with UE 101 to indicate the UE 101 will no longer receive wireless service from source service provider system 105. Such changes may be propagated to one or more elements of the wireless network associated with source service provider system 105, such that such elements do not provide wireless service to UE 101. Such changes may also include a transfer, release, etc. of the MDN associated with UE 101, such that the MDN may be used by target service provider system 103 to provide wireless service to UE 101. For example, source service provider system 105 may notify a central repository, database, authority, or other device or system that manages allocations or assignments of MDNs that the MDN is no longer associated with source service provider system 105, and/or that target service provider system 103 is authorized to use the MDN for UE 101.

Source service provider system 105 may indicate (at 216) that a portion of the service request, that is associated with source service provider system 105, has been fulfilled. That is, the “portion” of the service request associated with source service provider system 105, in this example, may include the updating of the provisioning information associated with UE 101 in one or more information resources associated with source service provider system 105 to indicate the UE 101 will no longer receive wireless service from source service provider system 105, changes propagated to the one or more elements of the wireless network associated with source service provider system 105, the transfer or release of the MDN, etc. Likewise, the “portion” of the service request associated with target service provider system 103 may include provisioning the MDN with one or more network elements associated with target service provider system 103, obtaining authorization from a central database to assign the MDN to UE 101, requesting the release of the MDN from source service provider system 105, or the like.

In this example, such indication may include an indication that the transfer of wireless service associated with UE 101 has been completed, and that target service provider system 103 may accordingly use the MDN, previously associated with UE 101 and source service provider system 105, to provide wireless service to UE 101.

Target service provider system 103 may output (at 218) an indication to tracker UI system 107 indicating that the service request has been fulfilled, completed, or the like. Tracker UI system 107 may update (at 220) the tracker UI, which may include updating a status indicated in the tracker UI to a completed status, such as “Your request is complete.” Tracker UI system 107 may further provide (at 220) the updated tracker UI to UE 101, as similarly discussed above. In some embodiments, target service provider system 103 may output (at 222) a notification to UE 101 that the requested service transfer has been completed. For example, target service provider system 103 may output a Short Message Service (“SMS”) message, a Multimedia Messaging Service (“MIMS”) message, an email, a telephone call, an in-app notification, or other suitable type of indication.

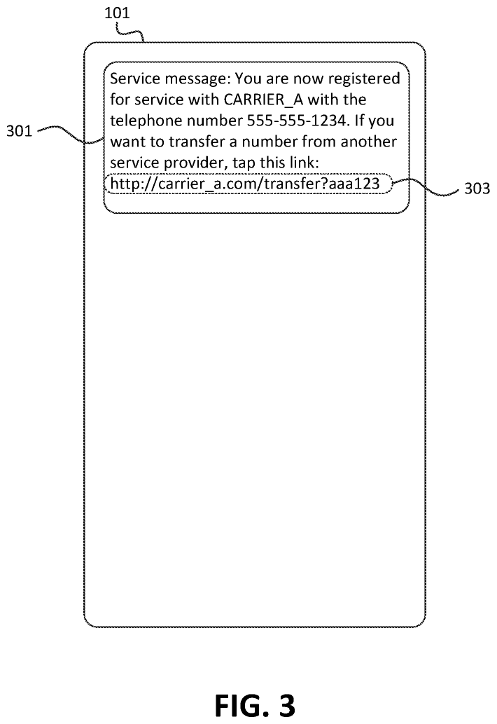

FIG. 3 illustrates an example message 301, which may include link 303 to initiate a service transfer request in accordance with some embodiments. For example, message 301 may be a SMS message, a MMS message, or some other suitable type of message sent to UE 101. In some embodiments, message 301 may be provided to UE 101 after UE 101 has registered with a first wireless network carrier, such as “CARRIER_A” (e.g., where CARRIER_A is, or includes, target service provider system 103 in this example). In some embodiments, UE 101 may register with the first wireless network carrier with a first set of service parameters, such as the MDN “555-555-1234” in this example. Selection of link 303 may initiate a service transfer request (e.g., service transfer request 102 shown in FIG. 1). In some embodiments, the service transfer request may be initiated in some other suitable manner (e.g., via a selection of a link on a web page, a selection of a graphical element such as a button in a GUI, a selection of an audible menu item in an audio-based system such as an interactive voice response (“IVR”) system, or the like).

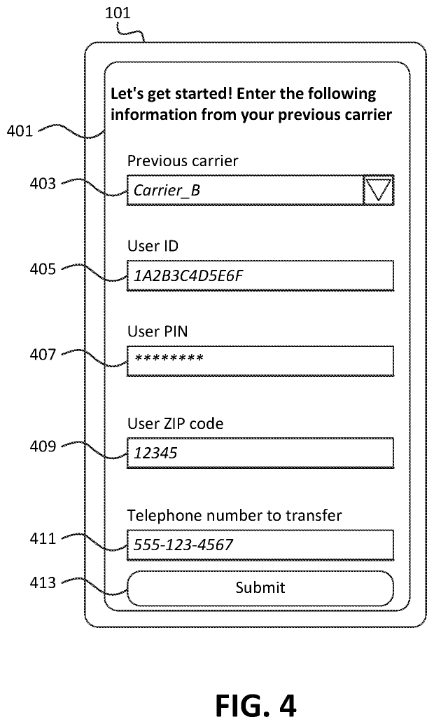

FIG. 4 illustrates example UI 401, which may allow for the selection or input of service transfer request parameters. For example, UI 401 may be provided by target service provider system 103, tracker UI system 107, or some other device or system. In some embodiments, UI 401 may be a web-accessible resource, such as a web page, a UI associated with an application (or “app”), or the like.

As shown, UI 401 may include interactive input elements 403-411. For example, input element 403 may allow a user to select a carrier from which a telephone number (e.g., MDN) should be transferred, input element 405 may allow the user to input a user identifier (“ID”) associated with the user with respect to the previous carrier, input element 407 may allow the user to enter a personal identification number (“PIN”), input element 409 may allow the user to enter a Zone Improvement Plan (“ZIP”) code, and input element 411 may allow the user to enter a MDN to be ported from the previous carrier (e.g., source service provider system 105) to the current carrier (e.g., target service provider system 103). In some embodiments, UI 401 may include additional, fewer, different, and/or differently arranged interactive elements. In some embodiments, input elements 403-411 may be text fields, menus, combo boxes, or other suitable types of interactive elements that receive user input.

As discussed above, some or all of the information received via input elements 403-411 may be validated by target service provider system 103 and/or source service provider system 105 as part of a service transfer request (e.g., the transfer of one or more aspects of service previously provided by source service provider system 105, such as a MDN associated with wireless service, to target service provider system 103). For example, in some embodiments, some or all of the information received via input elements 403-411 may be, or may include, service transfer request parameters (as referred to above). UI 401 may further include input element 413, which may be an option to submit the entered information (e.g., to target service provider system 103), thereby initiating the service transfer request (e.g., as discussed above with respect to service transfer request 102).

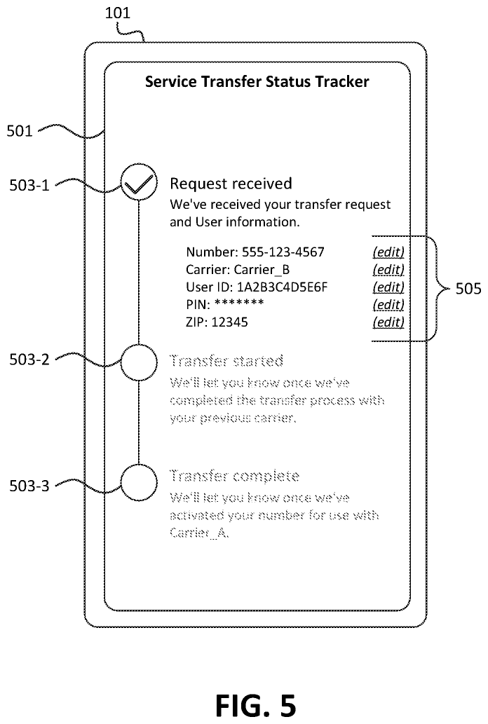

FIG. 5 illustrates an example tracker UI 501, which may be presented to UE 101. Tracker UI 501 may include status indicators 503-1, 503-2, and 503-3. Status indicators 503 may indicate one or more states or statuses associated with the request, the completion of one or more states, a present state, and information regarding one or more states that have yet to be completed. In this example, status indicator 503-1 may indicate the completion of an initialization state. The completion of a given state may be indicated by a check mark (e.g., as shown in FIG. 5) or by some other suitable indicator in tracker UI 501 and/or respective status indicator 503. In some embodiments, the check mark may indicate that a current state is in progress (e.g., not necessarily completed). Further, states that have not yet been started and/or completed may be indicated in a different manner than states that have been completed and/or are in progress. For example, status indicators 503-2 and 503-3 may not have a check mark, and text associated with the states that have not been completed may be presented differently than test associated with states that have been completed. In FIG. 5, for example, the “Transfer started” and “Transfer completed” states may be presented as different color text than the text associated with the “Request received” state.

Additionally, tracker UI 501 may indicate some or all of the request parameters, such as the input received via UI 401. Tracker UI 501 may also include edit options 505, which may allow a user to edit some or all of the request parameters. In some embodiments, when receiving updated request parameters, target service provider system 103 may update parameters associated with a request provided to source service provider system 105 (e.g., at 110 as shown in FIG. 1), and/or may issue a new request to source service provider system 105 with the updated request parameters.

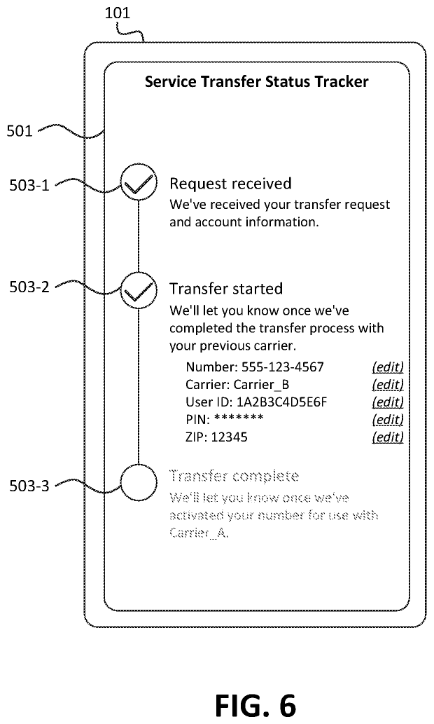

FIG. 6 illustrates example tracker UI 501 after the completion of the “Transfer started” state. This state may indicate, for example, that target service provider system 103 has outputted (at 110) a request to source service provider system 105 in accordance with the received request parameters. As similarly noted above, source service provider system 105 may evaluate the request parameters to determine whether the request parameters are valid or invalid, and may process the request when the request parameters are valid. Further, as noted above, in situations where source service provider system 105 determines (e.g., at 112) that one or more request parameters are invalid, source service provider system 105 may indicate (at 114) the invalid parameters to target service provider system 103.

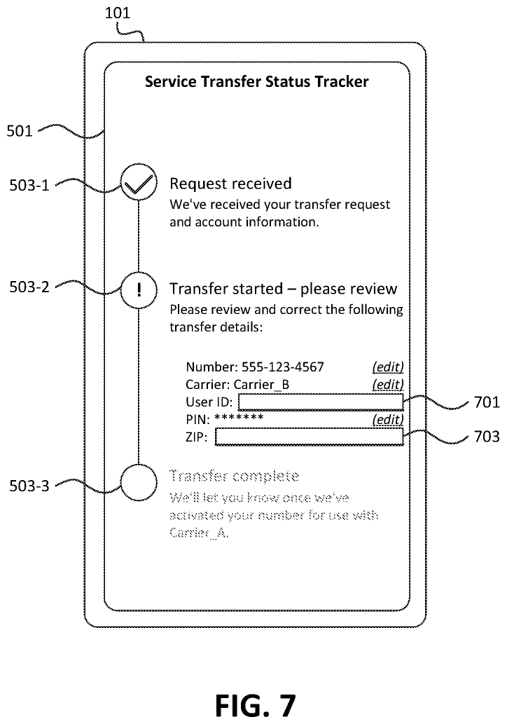

FIG. 7 illustrates example tracker UI 501 after one or more request parameters have been determined to be invalid. For example, as noted above, target service provider system 103 and/or tracker UI system 107 may have received (at 114 and/or at 116), from source service provider system 105, an indication that the “User ID” and “ZIP” parameters are invalid. In this example, status indicator 503-2 may be modified to indicate that an issue has arisen with respect to the state associated with status indicator 503-2. For example, as shown, an exclamation point may be used in status indicator 503-2 to indicate that an issue has arisen for this state. As further shown, text associated with this state may be modified to indicate that review and/or modification of one or more request parameters is needed in order to fulfill the request. For example, as shown in FIG. 7, the text associated with this state may be changed from “Transfer started” and “We'll let you know once we've completed the transfer process with your previous carrier” (e.g., as shown in FIG. 6) to “Transfer started—please review” and “Please review and correct the following transfer details.”

Further, tracker UI 501 may be modified to include input elements 701 and 703, which may each be associated with a respective one of the request parameters determined to be invalid. As noted above, the “User ID” and “ZIP” parameters may be invalid in this example. Accordingly, input element 701 may allow a user to provide a new value for the “User ID” parameter, and input element 703 may allow the user to provide a new value for the “ZIP” parameter. In some embodiments, input element 701 and input element 703 may be provided without receiving a user selection of a respective edit option 505 (e.g., an “edit” option) associated with these parameters. That is, input elements 701 and 703 may be presented automatically in some embodiments once target service provider system 103 and/or tracker UI system 107 receive an indication that the associated parameters are invalid. In this manner, a unified UI may be used for both status tracking of a service request as well as modification of parameters of the service request. Such unified UI may avoid the need for a user to place a call to a call center to provide updated parameters, open another application on UE 101 to provide updated parameters, and/or to otherwise navigate away from tracker UI 501.

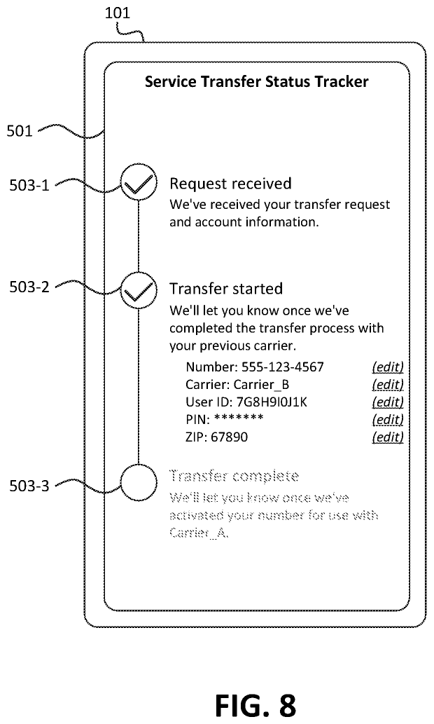

FIG. 8 illustrates example tracker UI 501 after the request parameters, indicated as invalid, have been modified (e.g., via input elements 701 and 703 of FIG. 7). For example, here, the “User ID” parameter may have been modified from “1A2B3C4D5E6F” to “7G8H9I0J1K” (e.g., via input element 701) and the “ZIP” parameter may have been modified from “12345” to “67890” (e.g., via input element 703). Further, status indicator 503-2 may be modified to remove the indication that an issue has arisen (e.g., the exclamation point shown in FIG. 7). For example, status indicator 503-2 in FIG. 8 may include a check mark to indicate that the “Transfer started” state has been completed (e.g., that the service transfer process has started, and validation from source service provider system 105 is needed before continuing to the next state.

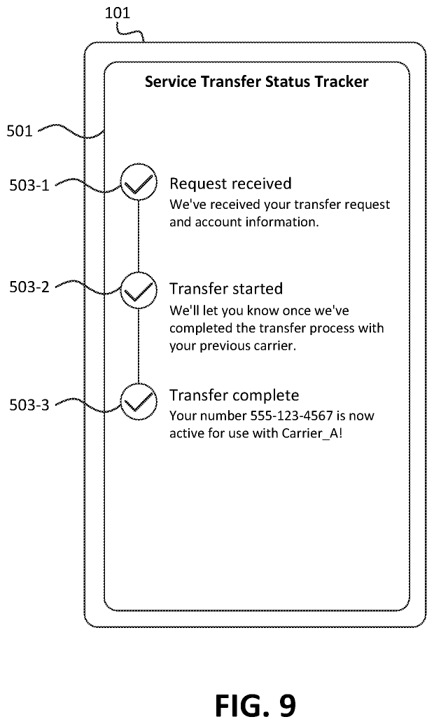

FIG. 9 illustrates example tracker UI 501 after the service transfer request has been fulfilled. For example, target service provider system 103 and/or tracker UI system 107 may have received (e.g., at 216 and/or 218) an indication that source service provider system 105 has validated the service parameters and/or has otherwise performed one or more operations related to the requested service, and that no outstanding issues remain from the standpoint of source service provider system 105 with the service transfer request. For example, source service provider system 105 may have deprovisioned UE 101 from a wireless network associated with source service provider system 105, may have removed the MDN previously associated with UE 101 from an internal database, may have issued a release to a central or external database with respect to the MDN, and/or may have performed one or more other suitable operations with respect to the service transfer request. Further, target service provider system 103 may have provisioned UE 101 with a wireless network associated with target service provider system 103, may have associated with UE 101 with the MDN transferred from source service provider system 105, and/or performed one or more other suitable operations with respect to the service transfer request or UE 101.

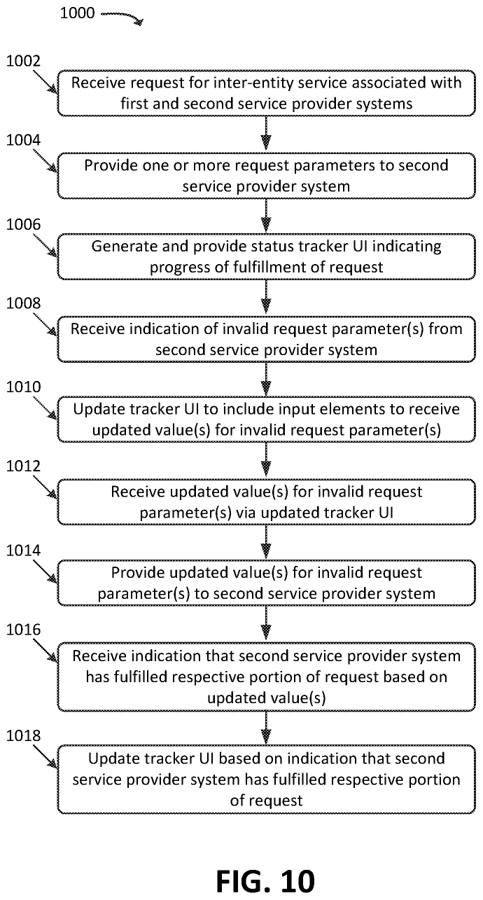

FIG. 10 illustrates an example process 1000 for providing a status tracker user interface UI for an inter-entity service request, including integrated input elements to receive updated values for request parameters invalidated by a second service provider system. In some embodiments, some or all of process 1000 may be performed by target service provider system 103 and/or tracker UI system 107. In some embodiments, one or more other devices may perform some or all of process 1000 in concert with, and/or in lieu of, target service provider system 103 and/or tracker UI system 107.

As shown, process 1000 may include receiving (at 1002) a request for an inter-entity service associated with first and second service provider systems. For example, the first service provider system (e.g., target service provider system 103) may receive the request from UE 101 or some other device or system. The inter-entity service may include a portion to be performed, fulfilled, completed, etc. by the second service provider system (e.g., source service provider system 105). In some embodiments, as discussed in the examples above, the request for the inter-entity service may include a transfer of aspects or parameters of wireless service, such as a MDN used by source service provider system 105 for UE 101.

Process 1000 may further include providing (at 1004) one or more of the request parameters to the second service provider system. For example, target service provider system 103 may output (e.g., via service provider broker system 109) a request for source service provider system 105 to perform the portion of the requested inter-entity service that is associated with source service provider system 105. For example, target service provider system 103 may request the release of the MDN associated with UE 101 from source service provider system 105, such that target service provider system 103 may use the MDN for UE 101.

Process 1000 may additionally include generating and providing (at 1006) a status tracker UI indicating the progress of the fulfillment of the request. For example, as discussed above, tracker UI system 107 may select a particular status tracker UI template out of a set of candidate status tracker UI templates based on the request. For example, as noted above, different status tracker UI templates may be associated with requests for different types of service and/or types of parameters included in such requests. Target service provider system 103 and/or tracker UI system 107 may update the status tracker over time based on the completion of discrete states associated with the request, as discussed above. For example, the status tracker may be updated to reflect that the parameters were provided (at 1004) to source service provider system 105, an amount of time that has passed since the parameters were provided to source service provider system 105, etc.

Process 1000 may also include receiving (at 1008) an indication of one or more invalid request parameters from the second service provider system. For example, target service provider system 103 may receive (e.g., via service provider broker system 109) an indication from source service provider system 105 that respective values for the one or more request parameters do not match expected values (e.g., values maintained by source service provider system 105 which are not otherwise accessible to target service provider system 103). Additionally, or alternatively, source service provider system 105 may indicate that one or more computations performed on the values (e.g., a hashing function, a cryptographic function, or the like) do not yield an expected result.

Process 1000 may further include updating (at 1010) the tracker UI to include input elements to receive updated values for the one or more invalid request parameters. For example, as discussed above, target service provider system 103 and/or tracker UI system 107 may modify the tracker UI to indicate that the respective values for the one or more parameters have been indicated as invalid by source service provider system 105. The tracker UI may further be updated to include one or more text boxes, list boxes, menus, combo boxes, or other types of input elements for each respective one of the parameters indicated as invalid.

Process 1000 may additionally include receiving (at 1012) respective updated values for the one or more invalid request parameters via the updated tracker UI. For example, target service provider system 103 may receive input via the input elements included in the updated tracker UI.

Process 1000 may also include providing (at 1014) the received updated values for the one or more invalid request parameters to the second service provider system. For example, target service provider system 103 may provide (e.g., via service provider broker system 109) the updated values to source service provider system 105. In some embodiments, target service provider system 103 may issue a new request with the updated values (e.g., in lieu of modifying or updating the previous request with the updated values). In some embodiments, target service provider system 103 and/or tracker UI system 107 may further update the tracker UI at this point to indicate that the updated values have been received and/or that the updated values have been forwarded to source service provider system 105.

Process 1000 may further include receiving (at 1016) an indication that the second service provider system has fulfilled a respective portion of the request, associated with the second service provider system, based on the updated values. For example, target service provider system 103 may receive an indication that source service provider system 105 has processed the request based on the updated values, that source service provider system 105 has fulfilled the respective portion of the request associated with source service provider system 105, and/or that source service provider system 105 has otherwise approved or validated the updated values.

Process 1000 may additionally include updating (at 1018) the tracker UI based on the indication that the second service provider system has fulfilled the respective portion of the request. For example, target service provider system 103 and/or tracker UI system 107 may update the status reflected in the tracker UI to indicate that source service provider system 105 has completed the respective portion of the request associated with source service provider system 105.

Prior to the completion of the portion of the request associated with source service provider system 105, concurrent with the completion of the portion of the request associated with source service provider system 105, and/or based on the completion of the portion of the request associated with source service provider system 105, target service provider system 103 may fulfill a respective portion of the request associated with target service provider system 103. For example, in the example above, target service provider system 103 may obtain authorization to use the MDN transferred by source service provider system 105 from a central MDN database or authority. Target service provider system 103 and/or tracker UI system 107 may further update the status tracker UI based on the completion or progress of the portions of the request associated with target service provider system 103.

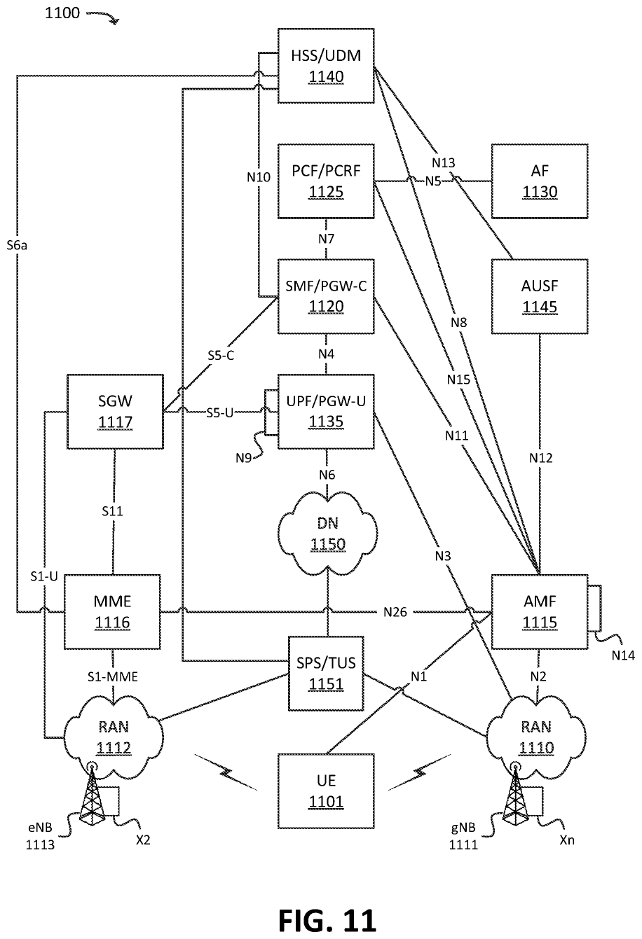

FIG. 11 illustrates an example environment 1100, in which one or more embodiments may be implemented. In some embodiments, environment 1100 may correspond to a Fifth Generation (“5G”) network, and/or may include elements of a 5G network. In some embodiments, environment 1100 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). As shown, environment 1100 may include UE 1101, RAN 1110 (which may include one or more Next Generation Node Bs (“gNBs”) 1111), RAN 1112 (which may include one or more one or more evolved Node Bs (“eNBs”) 1113), and various network functions such as Access and Mobility Management Function (“AMF”) 1115, Mobility Management Entity (“MME”) 1116, Serving Gateway (“SGW”) 1117, Session Management Function (“SMF”)/Packet Data Network (“PDN”) Gateway (“PGW”)-Control plane function (“PGW-C”) 1120, Policy Control Function (“PCF”)/Policy Charging and Rules Function (“PCRF”) 1125, Application Function (“AF”) 1130, User Plane Function (“UPF”)/PGW-User plane function (“PGW-U”) 1135, Home Subscriber Server (“HSS”)/Unified Data Management (“UDM”) 1140, and Authentication Server Function (“AUSF”) 1145. Environment 1100 may also include one or more networks, such as Data Network (“DN”) 1150. Environment 1100 may include one or more additional devices or systems communicatively coupled to one or more networks (e.g., DN 1150), such as service provider system/tracker UI system (“SPS/TUS”) 1151.

The example shown in FIG. 11 illustrates one instance of each network component or function (e.g., one instance of SMF/PGW-C 1120, PCF/PCRF 1125, UPF/PGW-U 1135, HSS/UDM 1140, and/or 1145). In practice, environment 1100 may include multiple instances of such components or functions. For example, in some embodiments, environment 1100 may include multiple “slices” of a core network, where each slice includes a discrete set of network functions (e.g., one slice may include a first instance of SMF/PGW-C 1120, PCF/PCRF 1125, UPF/PGW-U 1135, HSS/UDM 1140, and/or 1145, while another slice may include a second instance of SMF/PGW-C 1120, PCF/PCRF 1125, UPF/PGW-U 1135, HSS/UDM 1140, and/or 1145). The different slices may provide differentiated levels of service, such as service in accordance with different Quality of Service (“QoS”) parameters.

The quantity of devices and/or networks, illustrated in FIG. 11, is provided for explanatory purposes only. In practice, environment 1100 may include additional devices and/or networks, fewer devices and/or networks, different devices and/or networks, or differently arranged devices and/or networks than illustrated in FIG. 11. For example, while not shown, environment 1100 may include devices that facilitate or enable communication between various components shown in environment 1100, such as routers, modems, gateways, switches, hubs, etc. Alternatively, or additionally, one or more of the devices of environment 1100 may perform one or more network functions described as being performed by another one or more of the devices of environment 1100. Devices of environment 1100 may interconnect with each other and/or other devices via wired connections, wireless connections, or a combination of wired and wireless connections. In some implementations, one or more devices of environment 1100 may be physically integrated in, and/or may be physically attached to, one or more other devices of environment 1100.

UE 1101 may include a computation and communication device, such as a wireless mobile communication device that is capable of communicating with RAN 1110, RAN 1112, and/or DN 1150. UE 1101 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an IoT device (e.g., a sensor, a smart home appliance, or the like), a wearable device, an Internet of Things (“IoT”) device, a Mobile-to-Mobile (“M2M”) device, or another type of mobile computation and communication device. UE 1101 may send traffic to and/or receive traffic (e.g., user plane traffic) from DN 1150 via RAN 1110, RAN 1112, and/or UPF/PGW-U 1135.

RAN 1110 may be, or may include, a 5G RAN that includes one or more base stations (e.g., one or more gNBs 1111), via which UE 1101 may communicate with one or more other elements of environment 1100. UE 1101 may communicate with RAN 1110 via an air interface (e.g., as provided by gNB 1111). For instance, RAN 1110 may receive traffic (e.g., voice call traffic, data traffic, messaging traffic, signaling traffic, etc.) from UE 1101 via the air interface, and may communicate the traffic to UPF/PGW-U 1135, and/or one or more other devices or networks. Similarly, RAN 1110 may receive traffic intended for UE 1101 (e.g., from UPF/PGW-U 1135, AMF 1115, and/or one or more other devices or networks) and may communicate the traffic to UE 1101 via the air interface.

RAN 1112 may be, or may include, a LTE RAN that includes one or more base stations (e.g., one or more eNBs 1113), via which UE 1101 may communicate with one or more other elements of environment 1100. UE 1101 may communicate with RAN 1112 via an air interface (e.g., as provided by eNB 1113). For instance, RAN 1110 may receive traffic (e.g., voice call traffic, data traffic, messaging traffic, signaling traffic, etc.) from UE 1101 via the air interface, and may communicate the traffic to UPF/PGW-U 1135, and/or one or more other devices or networks. Similarly, RAN 1110 may receive traffic intended for UE 1101 (e.g., from UPF/PGW-U 1135, SGW 1117, and/or one or more other devices or networks) and may communicate the traffic to UE 1101 via the air interface.

AMF 1115 may include one or more devices, systems, Virtualized Network Functions (“VNFs”), etc., that perform operations to register UE 1101 with the 5G network, to establish bearer channels associated with a session with UE 1101, to hand off UE 1101 from the 5G network to another network, to hand off UE 1101 from the other network to the 5G network, manage mobility of UE 1101 between RANs 1110 and/or gNBs 1111, and/or to perform other operations. In some embodiments, the 5G network may include multiple AMFs 1115, which communicate with each other via the N14 interface (denoted in FIG. 11 by the line marked “N14” originating and terminating at AMF 1115).

MME 1116 may include one or more devices, systems, VNFs, etc., that perform operations to register UE 1101 with the EPC, to establish bearer channels associated with a session with UE 1101, to hand off UE 1101 from the EPC to another network, to hand off UE 1101 from another network to the EPC, manage mobility of UE 1101 between RANs 1112 and/or eNBs 1113, and/or to perform other operations.

SGW 1117 may include one or more devices, systems, VNFs, etc., that aggregate traffic received from one or more eNBs 1113 and send the aggregated traffic to an external network or device via UPF/PGW-U 1135. Additionally, SGW 1117 may aggregate traffic received from one or more UPF/PGW-Us 1135 and may send the aggregated traffic to one or more eNBs 1113. SGW 1117 may operate as an anchor for the user plane during inter-eNB handovers and as an anchor for mobility between different telecommunication networks or RANs (e.g., RANs 1110 and 1112).

SMF/PGW-C 1120 may include one or more devices, systems, VNFs, etc., that gather, process, store, and/or provide information in a manner described herein. SMF/PGW-C 1120 may, for example, facilitate in the establishment of communication sessions on behalf of UE 1101. In some embodiments, the establishment of communications sessions may be performed in accordance with one or more policies provided by PCF/PCRF 1125.

PCF/PCRF 1125 may include one or more devices, systems, VNFs, etc., that aggregate information to and from the 5G network and/or other sources. PCF/PCRF 1125 may receive information regarding policies and/or subscriptions from one or more sources, such as subscriber databases and/or from one or more users (such as, for example, an administrator associated with PCF/PCRF 1125).

AF 1130 may include one or more devices, systems, VNFs, etc., that receive, store, and/or provide information that may be used in determining parameters (e.g., quality of service parameters, charging parameters, or the like) for certain applications.

UPF/PGW-U 1135 may include one or more devices, systems, VNFs, etc., that receive, store, and/or provide data (e.g., user plane data). For example, UPF/PGW-U 1135 may receive user plane data (e.g., voice call traffic, data traffic, etc.), destined for UE 1101, from DN 1150, and may forward the user plane data toward UE 1101 (e.g., via RAN 1110, SMF/PGW-C 1120, and/or one or more other devices). In some embodiments, multiple UPFs 1135 may be deployed (e.g., in different geographical locations), and the delivery of content to UE 1101 may be coordinated via the N9 interface (e.g., as denoted in FIG. 11 by the line marked “N9” originating and terminating at UPF/PGW-U 1135). Similarly, UPF/PGW-U 1135 may receive traffic from UE 1101 (e.g., via RAN 1110, SMF/PGW-C 1120, and/or one or more other devices), and may forward the traffic toward DN 1150. In some embodiments, UPF/PGW-U 1135 may communicate (e.g., via the N4 interface) with SMF/PGW-C 1120, regarding user plane data processed by UPF/PGW-U 1135.

HSS/UDM 1140 and AUSF 1145 may include one or more devices, systems, VNFs, etc., that manage, update, and/or store, in one or more memory devices associated with AUSF 1145 and/or HSS/UDM 1140, profile information associated with a subscriber. AUSF 1145 and/or HSS/UDM 1140 may perform authentication, authorization, and/or accounting operations associated with the subscriber and/or a communication session with UE 1101.

DN 1150 may include one or more wired and/or wireless networks. For example, DN 1150 may include an Internet Protocol (“IP”)-based PDN, a wide area network (“WAN”) such as the Internet, a private enterprise network, and/or one or more other networks. UE 1101 may communicate, through DN 1150, with data servers, other UEs 1101, and/or to other servers or applications that are coupled to DN 1150. DN 1150 may be connected to one or more other networks, such as a public switched telephone network (“PSTN”), a public land mobile network (“PLMN”), and/or another network. DN 1150 may be connected to one or more devices, such as content providers, applications, web servers, and/or other devices, with which UE 1101 may communicate.

SPS/TUS 1151 may include one or more devices, systems, VNFs, etc., that perform one or more operations described above with respect to target service provider system 103 and/or tracker UI system 107. For example, SPS/TUS 1151 may receive requests for inter-service provider service, communicate with another service provider system (e.g., via DN 1150 and/or one or more other devices or systems), provide status updates regarding the fulfillment of the requests via a status tracker UI, receive updated request parameters via the status tracker UI, and/or perform other operations described herein.

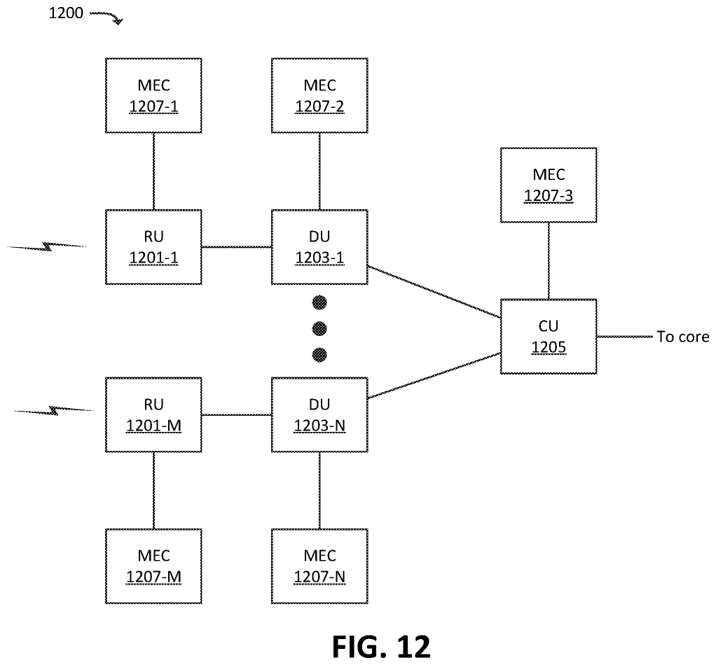

FIG. 12 illustrates an example Distributed Unit (“DU”) network 1200, which may be included in and/or implemented by one or more RANs (e.g., RAN 1110, RAN 1112, or some other RAN). In some embodiments, a particular RAN may include one DU network 1200. In some embodiments, a particular RAN may include multiple DU networks 1200. In some embodiments, DU network 1200 may correspond to a particular gNB 1111 of a 5G RAN (e.g., RAN 1110). In some embodiments, DU network 1200 may correspond to multiple gNBs 1111. In some embodiments, DU network 1200 may correspond to one or more other types of base stations of one or more other types of RANs. As shown, DU network 1200 may include Central Unit (“CU”) 1205, one or more Distributed Units (“DUs”) 1203-1 through 1203-N (referred to individually as “DU 1203,” or collectively as “DUs 1203”), and one or more Radio Units (“RUs”) 1201-1 through 1201-M (referred to individually as “RU 1201,” or collectively as “RUs 1201”).

CU 1205 may communicate with a core of a wireless network (e.g., may communicate with one or more of the devices or systems described above with respect to FIG. 11, such as AMF 1115 and/or UPF/PGW-U 1135). In the uplink direction (e.g., for traffic from UEs 1101 to a core network), CU 1205 may aggregate traffic from DUs 1203, and forward the aggregated traffic to the core network. In some embodiments, CU 1205 may receive traffic according to a given protocol (e.g., Radio Link Control (“RLC”)) from DUs 1203, and may perform higher-layer processing (e.g., may aggregate/process RLC packets and generate Packet Data Convergence Protocol (“PDCP”) packets based on the RLC packets) on the traffic received from DUs 1203.

In accordance with some embodiments, CU 1205 may receive downlink traffic (e.g., traffic from the core network) for a particular UE 1101, and may determine which DU(s) 1203 should receive the downlink traffic. DU 1203 may include one or more devices that transmit traffic between a core network (e.g., via CU 1205) and UE 1101 (e.g., via a respective RU 1201). DU 1203 may, for example, receive traffic from RU 1201 at a first layer (e.g., physical (“PHY”) layer traffic, or lower PHY layer traffic), and may process/aggregate the traffic to a second layer (e.g., upper PHY and/or RLC). DU 1203 may receive traffic from CU 1205 at the second layer, may process the traffic to the first layer, and provide the processed traffic to a respective RU 1201 for transmission to UE 1101.

RU 1201 may include hardware circuitry (e.g., one or more RF transceivers, antennas, radios, and/or other suitable hardware) to communicate wirelessly (e.g., via an RF interface) with one or more UEs 1101, one or more other DUs 1203 (e.g., via RUs 1201 associated with DUs 1203), and/or any other suitable type of device. In the uplink direction, RU 1201 may receive traffic from UE 1101 and/or another DU 1203 via the RF interface and may provide the traffic to DU 1203. In the downlink direction, RU 1201 may receive traffic from DU 1203, and may provide the traffic to UE 1101 and/or another DU 1203.

RUs 1201 may, in some embodiments, be communicatively coupled to one or more Multi-Access/Mobile Edge Computing (“MEC”) devices, referred to sometimes herein simply as (“MECs”) 1207. For example, RU 1201-1 may be communicatively coupled to MEC 1207-1, RU 1201-M may be communicatively coupled to MEC 1207-M, DU 1203-1 may be communicatively coupled to MEC 1207-2, DU 1203-N may be communicatively coupled to MEC 1207-N, CU 1205 may be communicatively coupled to MEC 1207-3, and so on. MECs 1207 may include hardware resources (e.g., configurable or provisionable hardware resources) that may be configured to provide services and/or otherwise process traffic to and/or from UE 1101, via a respective RU 1201.

For example, RU 1201-1 may route some traffic, from UE 1101, to MEC 1207-1 instead of to a core network (e.g., via DU 1203 and CU 1205). MEC 1207-1 may process the traffic, perform one or more computations based on the received traffic, and may provide traffic to UE 1101 via RU 1201-1. In this manner, ultra-low latency services may be provided to UE 1101, as traffic does not need to traverse DU 1203, CU 1205, and an intervening backhaul network between DU network 1200 and the core network. In some embodiments, MEC 1207 may include, and/or may implement, some or all of the functionality described above with respect to SPS/TUS 1151.

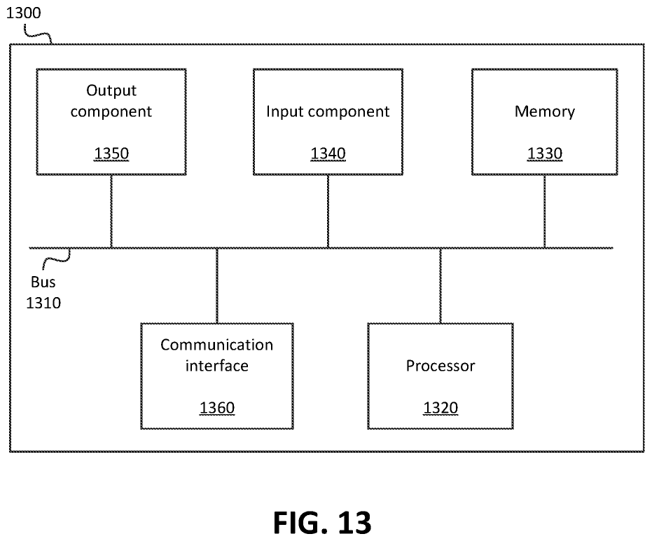

FIG. 13 illustrates example components of device 1300. One or more of the devices described above may include one or more devices 1300. Device 1300 may include bus 1310, processor 1320, memory 1330, input component 1340, output component 1350, and communication interface 1360. In another implementation, device 1300 may include additional, fewer, different, or differently arranged components.

Bus 1310 may include one or more communication paths that permit communication among the components of device 1300. Processor 1320 may include a processor, microprocessor, or processing logic that may interpret and execute instructions. Memory 1330 may include any type of dynamic storage device that may store information and instructions for execution by processor 1320, and/or any type of non-volatile storage device that may store information for use by processor 1320.

Input component 1340 may include a mechanism that permits an operator to input information to device 1300 and/or other receives or detects input from a source external to 1340, such as a touchpad, a touchscreen, a keyboard, a keypad, a button, a switch, a microphone or other audio input component, etc. In some embodiments, input component 1340 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1350 may include a mechanism that outputs information to the operator, such as a display, a speaker, one or more light emitting diodes (“LEDs”), etc.

Communication interface 1360 may include any transceiver-like mechanism that enables device 1300 to communicate with other devices and/or systems. For example, communication interface 1360 may include an Ethernet interface, an optical interface, a coaxial interface, or the like. Communication interface 1360 may include a wireless communication device, such as an infrared (“IR”) receiver, a Bluetooth® radio, or the like. The wireless communication device may be coupled to an external device, such as a remote control, a wireless keyboard, a mobile telephone, etc. In some embodiments, device 1300 may include more than one communication interface 1360. For instance, device 1300 may include an optical interface and an Ethernet interface.

Device 1300 may perform certain operations relating to one or more processes described above. Device 1300 may perform these operations in response to processor 1320 executing software instructions stored in a computer-readable medium, such as memory 1330. A computer-readable medium may be defined as a non-transitory memory device. A memory device may include space within a single physical memory device or spread across multiple physical memory devices. The software instructions may be read into memory 1330 from another computer-readable medium or from another device. The software instructions stored in memory 1330 may cause processor 1320 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1, 2, and 10), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device associated with a first service provider system, the device comprising:
one or more processors configured to:
receive from a first User Equipment (“UE”), a request for an inter-entity service, the inter-entity service including a first portion associated with the first service provider system and a second portion associated with a second provider system, the request including a set of parameters;
identify one or more parameters, of the set of parameters, to provide to the second service provider system;
provide a status tracker user interface (“UI”) to the UE, the status tracker UI indicating a progress of fulfillment of the request;
output, to the second service provider system, the identified one or more parameters;
update the status tracker UI based on the one or more parameters having been output to the second service provider system;
receive, from the second service provider system, an indication that at least one of the one or more parameters output to the second service provider system are invalid;
update the status tracker UI to include one or more input elements to receive an updated value for the indicated at least one parameter;
receive, via the updated status tracker UI, the updated value for the at least one parameter;
output, to the second service provider system, the updated value for the at least one parameter; and
receive, from the second service provider system, an indication that the second portion of the request, that is associated with the second service provider system, has been fulfilled by the second service provider system.

2. The device of claim 1, wherein the one or more processors are further configured to:
further update the status tracker UI to indicate that the second portion of the request has been fulfilled by the second service provider system.

3. The device of claim 1, wherein the updated status tracker UI that includes the one or more input elements further indicates that the status of the fulfillment includes an indication, from the second service provider system, of an invalid value of the at least one parameter.

4. The device of claim 1, wherein the second portion of the inter-entity service includes a release of a Mobile Directory Number (“MDN”), associated with the UE, by the second service provider system.

5. The device of claim 1, wherein the at least one parameter includes two or more parameters, wherein the one or more input elements include two or more input elements that each correspond to a respective one of the two or more parameters.

6. The device of claim 1, wherein the one or more processors are further configured to:
identify a type of the request;
select a particular status tracker UI template from a plurality of status tracker UI templates based on the identified type of request; and
generate the status tracker UI based on the selected status tracker UI and the identified set of parameters associated with the request.

7. The device of claim 1, wherein the first service provider system is associated with a first wireless network carrier, and wherein the second service provider system is associated with a different second wireless network carrier.

8. A non-transitory computer-readable medium, storing a plurality of processor-executable instructions to:
receive from a first User Equipment (“UE”), a request for an inter-entity service, the inter-entity service including a first portion associated with a first service provider system and a second portion associated with a second provider system, the request including a set of parameters;
identify one or more parameters, of the set of parameters, to provide to the second service provider system;
provide a status tracker user interface (“UI”) to the UE, the status tracker UI indicating a progress of fulfillment of the request;
output, to the second service provider system, the identified one or more parameters;
update the status tracker UI based on the one or more parameters having been output to the second service provider system;
receive, from the second service provider system, an indication that at least one of the one or more parameters output to the second service provider system are invalid;
update the status tracker UI to include one or more input elements to receive an updated value for the indicated at least one parameter;
receive, via the updated status tracker UI, the updated value for the at least one parameter;
output, to the second service provider system, the updated value for the at least one parameter; and
receive, from the second service provider system, an indication that the second portion of the request, that is associated with the second service provider system, has been fulfilled by the second service provider system.

9. The non-transitory computer-readable medium of claim 8, wherein the plurality of processor-executable instructions further include processor-executable instructions to:
further update the status tracker UI to indicate that the second portion of the request has been fulfilled by the second service provider system.

10. The non-transitory computer-readable medium of claim 8, wherein the updated status tracker UI that includes the one or more input elements further indicates that the status of the fulfillment includes an indication, from the second service provider system, of an invalid value of the at least one parameter.

11. The non-transitory computer-readable medium of claim 8, wherein the second portion of the inter-entity service includes a release of a Mobile Directory Number (“MDN”), associated with the UE, by the second service provider system.

12. The non-transitory computer-readable medium of claim 8, wherein the at least one parameter includes two or more parameters, wherein the one or more input elements include two or more input elements that each correspond to a respective one of the two or more parameters.

13. The non-transitory computer-readable medium of claim 8, wherein the plurality of processor-executable instructions further include processor-executable instructions to:
identify a type of the request;
select a particular status tracker UI template from a plurality of status tracker UI templates based on the identified type of request; and
generate the status tracker UI based on the selected status tracker UI and the identified set of parameters associated with the request.

14. A method, comprising:
receiving, by a first service provider system and from a first User Equipment (“UE”), a request for an inter-entity service, the inter-entity service including a first portion associated with the first service provider system and a second portion associated with a second provider system, the request including a set of parameters;
identifying one or more parameters, of the set of parameters, to provide to the second service provider system;
providing a status tracker user interface (“UI”) to the UE, the status tracker UI indicating a progress of fulfillment of the request;
outputting, to the second service provider system, the identified one or more parameters;
updating the status tracker UI based on the one or more parameters having been output to the second service provider system;
receiving, from the second service provider system, an indication that at least one of the one or more parameters output to the second service provider system are invalid;
updating the status tracker UI to include one or more input elements to receive an updated value for the indicated at least one parameter;
receiving, via the updated status tracker UI, the updated value for the at least one parameter;
outputting, to the second service provider system, the updated value for the at least one parameter; and
receiving, from the second service provider system, an indication that the second portion of the request, that is associated with the second service provider system, has been fulfilled by the second service provider system.

15. The method of claim 14, further comprising:
further updating the status tracker UI to indicate that the second portion of the request has been fulfilled by the second service provider system.

16. The method of claim 14, wherein the updated status tracker UI that includes the one or more input elements further indicates that the status of the fulfillment includes an indication, from the second service provider system, of an invalid value of the at least one parameter.

17. The method of claim 14, wherein the second portion of the inter-entity service includes a release of a Mobile Directory Number (“MDN”), associated with the UE, by the second service provider system.

18. The method of claim 14, wherein the at least one parameter includes two or more parameters, wherein the one or more input elements include two or more input elements that each correspond to a respective one of the two or more parameters.

19. The method of claim 14, the method further comprising:
identifying a type of the request;
selecting a particular status tracker UI template from a plurality of status tracker UI templates based on the identified type of request; and
generating the status tracker UI based on the selected status tracker UI and the identified set of parameters associated with the request.

20. The method of claim 14, wherein the first service provider system is associated with a first wireless network carrier, and wherein the second service provider system is associated with a different second wireless network carrier.
